(19) United States
(12) Patent Application Publication
(10) Pub. No.: US 2006/0279519 A1
(43) Pub. Date: Dec. 14, 2006

(54) Low voltage differential signal direct transmission method and interface

(75) Inventor: Yu-Shen Wang, Taipei (TW)

Correspondence Address: Thomas E. Sisson;Jackson Walker, LLP, Suite 2100, 112 E. Pecan, San Antonio, TX, 78205, US

(73) Assignee: AMI Technologies Limited

(21) Appl. No.: 11/344,405

(22) Filed: Jan. 31, 2006

(30) Foreign Application Priority Data
Jun. 13, 2005 (TW) 094119480

(51) Int. Cl. G09G 3/36

(52) U.S. Cl. 345/102

(57) ABSTRACT

A low voltage differential signal (LVDS) direct transmission method and interface in accordance with the present invention are used to directly transmit LVDS from a graphic/video source to a display without digital to analog (D/A) or analog to digital (A/D) conversion and maintain optimal image quality. The interface has a signal filter, a panel power control unit, a backlight power control unit, a parameter storage unit and a bus. The interface cooperates with a display to control outputs of a power signal, an LVDS signal and backlight power signal, whereby noise is removed and an optical image quality is maintained.

### BACKGROUND OF THE INVENTION

1. Field of the Invention

The present invention relates to a method and a graphic/video data transmission interface, and particularly to a low voltage differential signal (LVDS) direct transmission method and interface to transmit graphic/video data from a data source directly to a display without digital to analog (D/A) or analog to digital (A/D) conversion.

2. Description of the Related Art

A conventional liquid crystal display (LCD) is composed of an LCD panel and a printed circuit board (PCB). The PCB normally has integrated circuits such as an A/D converter, a scaler, a micro-programmed control unit (MCU), an on-screen display (OSD) and a low voltage differential signal (LVDS) interface.

The format of the graphic/video data has to be converted several times before being received in and shown on a conventional LCD or a plasma display panel (PDP). Firstly, the graphic/video data format is converted from digital to analog at the source site and transmitted to the display LCD or PDP where the analog data is converted to digital LVDS data.

The foregoing two conversions are meaningless, and the data may be distorted during the conversions. Consequently, the image on the display may possibly be degraded with snow, image shifts or ripples or simply be out of focus.

The Extended Display Identification Date (EDID) of a conventional panel provided to the graphic/video source is not sufficient, so the LVDS only contains red, green and blue colors, a horizontal scan frequency, a vertical scan frequency and pixel frequency. However, no signal is provided to control power sequence, noise filtering or signal strength (quality) for the display. In that case, inappropriate power sequencing generates noise and shortens the service life of the display, and inappropriate signal quality is incompatible with different panels.

Therefore, the invention provides a direct LVDS transmission method and interface to mitigate or obviate the aforementioned problems.

### SUMMARY OF THE INVENTION

The main objective of the present invention is to provide a low voltage differential signal (LVDS) direct transmission method and interface, by which the LVDS can be transmitted directly from a graphic/video source to a display without digital to analog (D/A) or analog to digital (A/D) conversion and maintain optimal image quality.

Other objectives, advantages and novel features of the invention will become more apparent from the following detailed description when taken in conjunction with the accompanying drawings.

### BRIEF DESCRIPTION OF THE DRAWINGS

FIG. 1 is a block diagram of an LVDS interface in accordance with the invention;

FIG. 2 is a sequence diagram of power control in the LVDS interface in FIG. 1;

FIG. 3 is an oscillogram of a PWM signal that controls backlight brightness of a display;

FIG. 4 is a table of some parameters stored in a panel parameter storing unit of the LVDS interface in FIG. 1; and

FIG. 5 is a logic diagram of a method using the LVDS interface in FIG. 1 to transmit LVDS.

### DETAILED DESCRIPTION OF THE PREFERRED EMBODIMENT

A low voltage differential signal (LVDS) direct transmission method and interface in accordance with the present invention are used to directly transmit LVDS from a graphic/video source to a display without digital to analog (D/A) or analog to digital (AID) conversion and maintain optimal image quality.

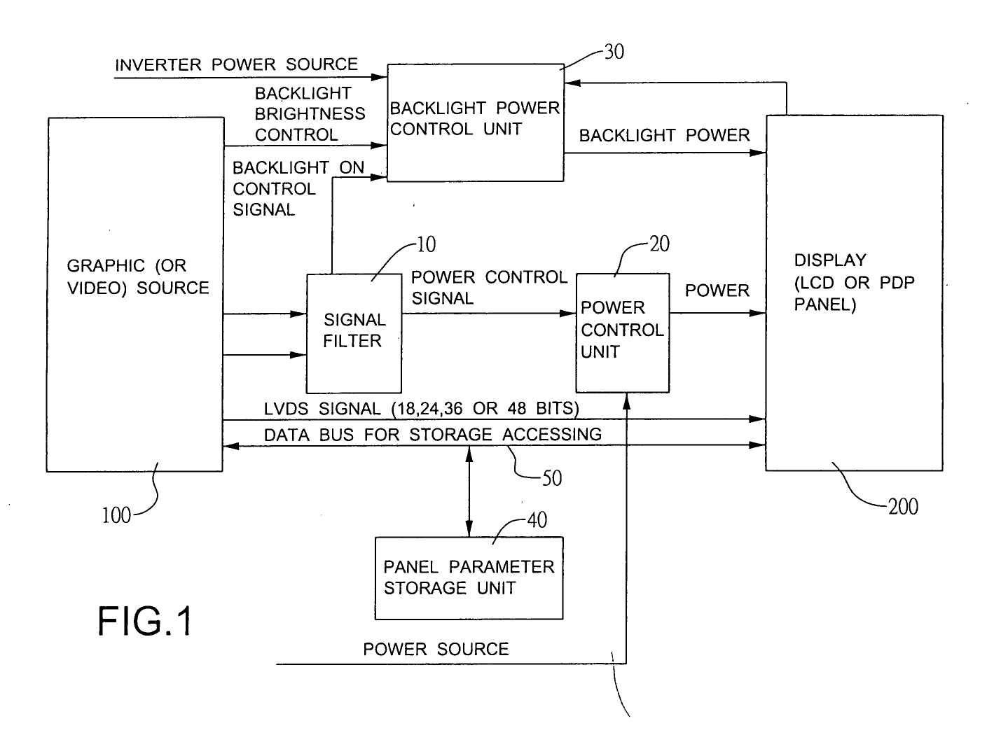

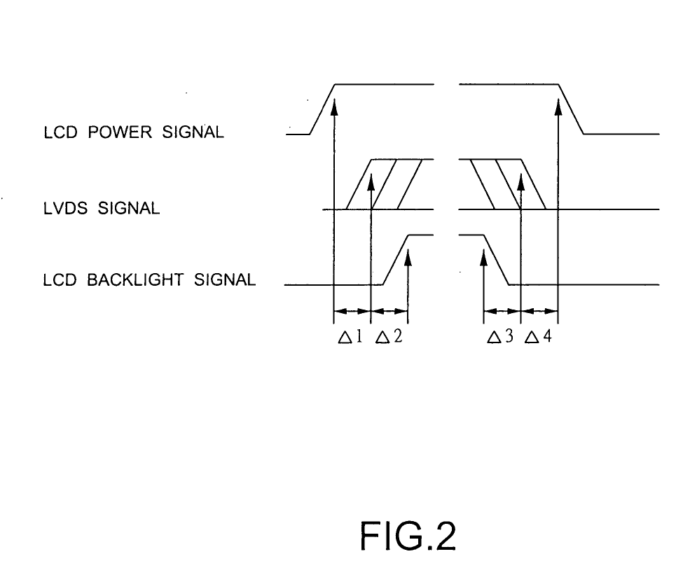

With reference to FIGS. 1 and 2, the LVDS interface is connected between a graphic/video source (100) and a display (200). The graphic/video source (100) can be a graphic/video integrated circuit or a display card or the like, generates backlight brightness and activation signals and power control signals and has an external power source (not shown). The display (200) can be a liquid crystal display (LCD), a plasma display panel (PDP) or other kinds of displays and has a backlight (not shown).

The interface comprises a signal filter (10), a power control unit (20), a backlight power control unit (30), a parameter storage unit (40) and a data bus (50).

The signal filter (10) is connected to the graphic/video source and isolates noise generated when the graphic/video source (100) is activated.

With further reference to FIG. 2, the power control unit (20) is connected to the graphic/video source through the signal filter (10), to a power source (not numbered) and to the display (200) and implements a proper sequence to apply power to the display (200).

The backlight power control unit (30) is connected to an inverter power source, directly to the graphic/video source (100) and to the graphic/video source (100) through the signal filter (10), receives backlight brightness control signals (not numbered) from the graphic/video source (100) and a backlight activation signal (not numbered) from the graphic/video source (100) through the signal filter (10) and controls the power sequence and the brightness for the backlight in the display (200).

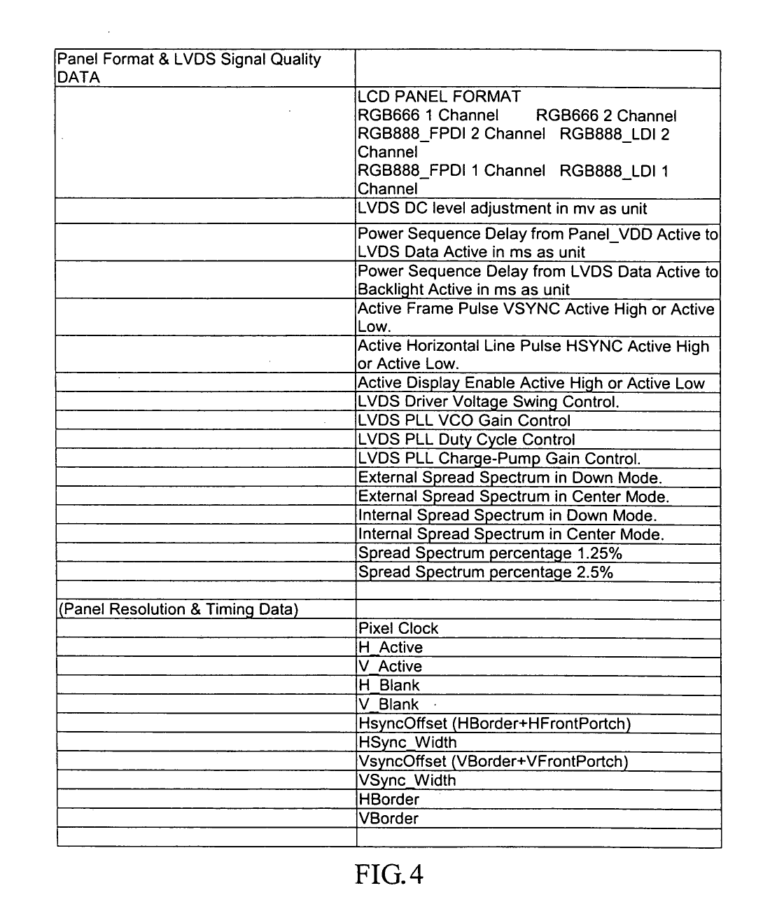

With further reference to FIG. 4, the parameter storage unit (40) can be an electrically erasable programmable read only memory (EEPROM) and is mounted in the display (200) to store variable display operating parameters. The data in the memory must reflect required values for the specific panel being driven. In addition to the original LVDS criterion, the data in the memory further includes control signals for power sequencing to remove noise generated during display mode changes or power up operations. Preferably, the EEPROM has a capacity of at least 128 bytes.

The bus (50) connects the graphic/video source (100), the display (200) and the parameter storage unit (40) and uses an inter-integrated circuit bus (I²C Bus) protocol.

Asynchronous signals comprise display power signal, LVDS and backlight power signal, that are asynchronous. The panel power signal is firstly output to activate the display (200). After a first delay Δ 1, the LVDS is then output to the display (200). After a second delay Δ 2, the backlight power signal is output. To turn off power to the display (200), the turn-off sequence is a mirror image of the turn-on sequence. That is, the backlight power signal stops first. After a third delay Δ 3, the LVDS shuts down, and after a fourth delay Δ 4, the panel power signal shuts down.

The foregoing procedure of controlling timing sequences can ensure that noise caused by initialization or display mode changes is totally eliminated and prolong the service life of the display (200).

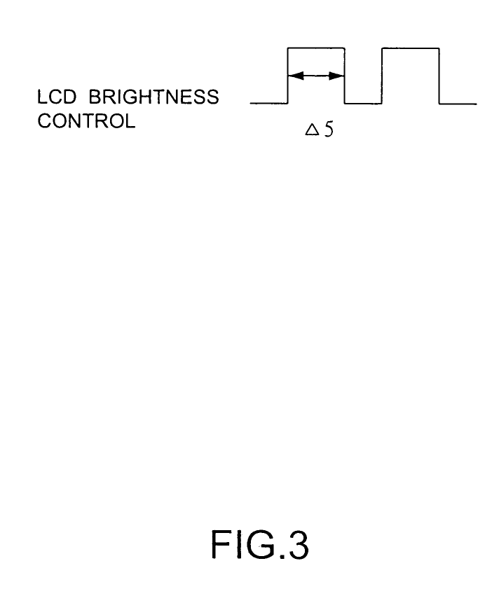

With further reference to FIG. 3, a PWM signal is used to control the brightness of the display (200) by adjusting a fifth delay Δ 5. Moreover, the fifth delay Δ 5 is adjusted based on the incoming image and the characteristics of the display (200) without the need of an additional PWM signal control circuit.

The panel parameter storing unit (40) stores multiple kinds of controlling parameters corresponding to the panel to be controlled, besides the original LVDS specifications.

The parameters comprises:

1. Power control of the display, LVDS specifications and time sequence of backlight power signal

2. LVDS RGB format (18/24/36/48 bit) (different panels use different RGB formats, and different panel resolution will use different LVDS channels) and number of LVDS channels

3. ON/OFF of Spread Spectrum, and a proportion defined in the EEPROM (if it is ON, the percentage can be defined in some area of the specific EEPROM)

4. LVDS driving strength and signal amplitude and DC voltage potential

5. LVDS PLL Voltage Gain Control

6. LVDS PLL Duty Cycle Control

7. LVDS PLL Charge-Pump Control

8. The Panel timing control data such as: Pixel Clock, Horizontal/Vertical resolution, H_Sync width, V_Sync width, H_Fron_Porch, V_Fron_Portch, H_Blank/V_Blank, H_Border/V_Border, . . .

9. LCD/PDP activation based on edges of Horizontal and vertical synchronization, and control signal.

The data will be all stored in EEPROM (Unit_40 in FIG. 1). The Graphic (or Video) source (Unit_100 in FIG. 1) will generate the proper signal and timing for the display target (Unit_200 in FIG. 1).

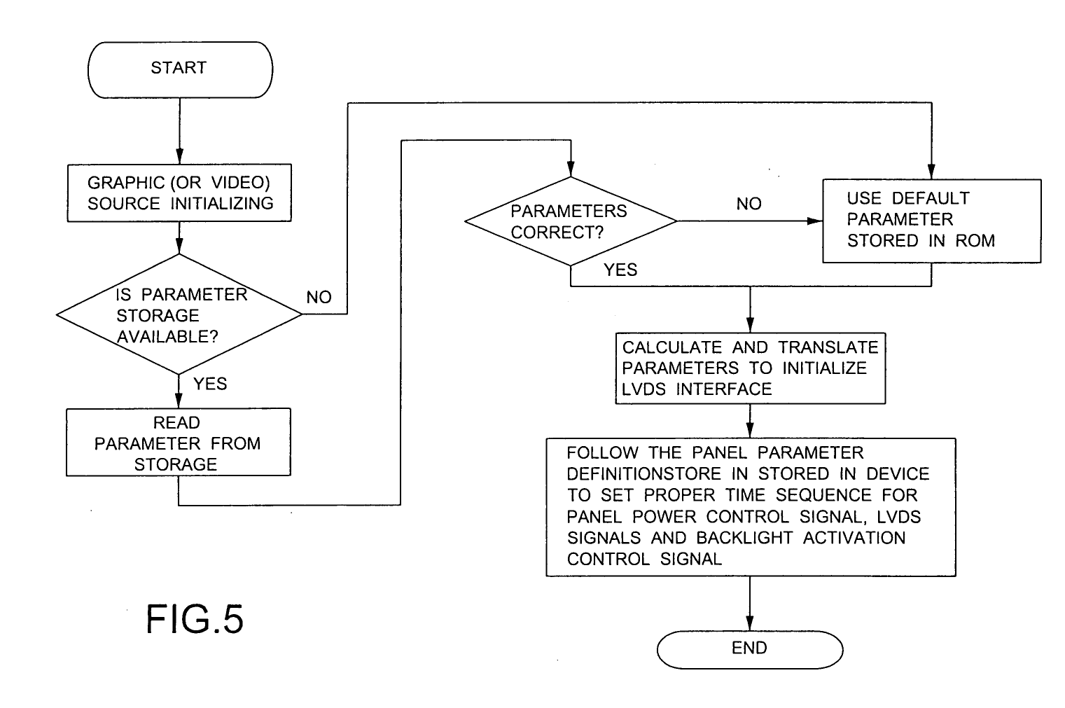

With further reference to FIG. 5, the LVDS direct transmission method comprises acts of initializing the graphic/video source; detecting whether the display (200) has a parameter storing unit (40) corresponding to the panel of the display; reading the corresponding parameters from the storing unit (40); checking whether the parameters are correct. If the parameters are right, the parameters will be calculated and translated to initialize the LVDS interface. Finally, the timing sequences of a panel power control signal, LVDS signals and a backlight activation control signal are determined based on those parameters.

In addition to the foregoing features of this invention, a plug & display function is also supported in this invention. As the graphic/video source (100) automatically gets the information and characteristics of all the displays (200), most proper data is provided to the display (200).

Even though numerous characteristics and advantages of the present invention have been set forth in the foregoing description, together with details of the structure and function of the invention, the disclosure is illustrative only. Changes may be made in the details, especially in matters of shape, size and arrangement of parts within the principles of the invention to the full extent indicated by the broad general meaning of the terms in which the appended claims are expressed.

What is claimed is:

1. An low voltage differential signal (LVDS) direct transmission interface connected between a graphic/video source and a display, the interface comprising:
a signal filter being connected to a graphic/video source and isolating noise generated when the graphic/video source is activated;
a power control unit being connected to the graphic/video source through the signal filter, to a power source and to the display and implementing a power sequence for the display;
a backlight power control unit controlling a power sequence and brightness for a backlight in the display;
a parameter storage unit being mounted in the display to store display operating parameters; and
a data bus connecting the graphic/video source, the display and the parameter storing unit.

2. The interface as claimed in claim 1, wherein the parameter storage unit is an Electrically Erasable Programmable Read Only Memory (EEPROM).

3. The interface as claimed in claim 1, wherein an inter-integrated circuit bus (I²C Bus) protocol is applied in the bus.

4. The interface as claimed in claim 3, wherein operating parameters corresponding to the display stored the parameter storing unit comprise: LVDS RGB (format 18/24/36/48 bit), number of LVDS channels, LVDS driving strength and signal amplitude and DC voltage potential, extended (square) EDID.

5. The interface as claimed in claim 4, wherein operating parameters stored in the parameter storing unit further comprise: ON/OFF of a Spread Spectrum function, and a proportion defined in the EEPROM; LVDS PLL Voltage Gain Control; LVDS PLL Duty Cycle Control; and LVDS PLL Charge-Pump Control.

6. The interface as claimed in claim 5, wherein when power of the display is activated, power signal, LVDS and backlight power signal are output in sequence; when power is turned off, the backlight power signal, the LVDS, the panel power signal are turned off in sequence.

7. The interface as claimed in claim 6, wherein a PWM signal is used to control the brightness of the display.

8. A LVDS direct transmission method of signals comprising acts of:
initializing the graphic/video source;
detecting whether the display has a parameter storing unit corresponding to a panel of the display;
reading the corresponding parameters from the storing unit;
checking whether the parameters are correct;
calculating and translating the parameters to initialize an LVDS interface if the parameters are correct; and
determining timing sequences of panel power signals, LVDS signals and backlight power control signals based on the parameters.

9. The method as claimed in claim 8, wherein when power of the display is activated, the panel power signals, LVDS signals and backlight power control signals are output in sequence; when the power is turned off, the backlight power signals, the LVDS signals and the panel power control signals are turned off in sequence.

10. The method as claimed in claim 9, wherein a PWM signal is used to control the brightness of the display.
